(19) United States
(12) Patent Application Publication
(10) Pub. No.: US 2012/0026033 A1
(43) Pub. Date: Feb. 2, 2012

(54) POSITION CALCULATION METHOD AND APPARATUS WITH GPS

(75) Inventor: Kazuyuki Shiomi, Wako-shi (JP)

(73) Assignee: HONDA MOTOR CO., LTD., Tokyo (JP)

(21) Appl. No.: 13/195,452

(22) Filed: Aug. 1, 2011

(30) Foreign Application Priority Data
Aug. 2, 2010 (JP) 2010-173824
Aug. 24, 2010 (JP) 2010-187562

(51) Int. Cl. G01S 19/42

(52) U.S. Cl. 342/357.25

(57) ABSTRACT

A GPS position calculating apparatus is configured to acquire orbit information from navigation data contained in signals transmitted from GPS satellites, the orbit information including a position, clock time and orbital speed of each GPS satellite at a transmission time of each signal, to calculate a position of each GPS satellite at a reception time of the same signal at a measurement point, from the acquired orbital speed and clock time, to calculate a range of a line segment connecting the calculated position of each GPS satellite with a position of the measurement point using a time difference between the transmission time and the reception time, and to calculate the position of the measurement point using the calculated range of the line segment as a pseudorange. A GPS position calculating method carried out by the apparatus is also disclosed.

### FIELD OF THE INVENTION

The present invention relates to a method of and an apparatus for calculating the position of a measurement point on the earth or the positions of plural GPS (global positioning system) satellites by using signals received from the GPS satellites.

### BACKGROUND OF THE INVENTION

In order to perform detection of an actual position of a GPS receiver, the GPS receiver needs to learn the distances to GPS satellites and positions of the GPS satellites. Signals transmitted from the GPS satellites are modulated and contain data called “navigation message”, which includes orbit information. The navigation message will be hereinafter referred to as “navigation data”.

The GPS receiver receives navigation data from the GPS satellites and by measuring positions of the GPS satellites and the distances from the GPS satellites to a measurement point, the GPS receiver detects a position of the measurement point, which is constituted by a movable object, such as an automobile, marine vessel, aircraft, working vehicle, or mobile terminal.

The GPS receiver involves a time difference Δt between a transmission time at which a signal is transmitted from each GPS satellite, and a reception time at which the same signal is received at the GPS receiver. In this instance, if an internal clock of the GPS receiver and atomic clocks in the GPS satellites are in perfect synchronization with each other, the GPS receiver receives navigation data with a delay corresponding to a transit time of radio wave. The GPS receiver is, therefore, able to determine the distance to the GPS satellite by multiplying the transit time of radio wave with the speed of light (propagation velocity of electromagnetic field).

However, the GPS receiver clock often goes out of synchronization with the GPS satellites clocks. Thus, the GPS receiver determines the distance to each GPS satellite as a “pseudorange”, which involves clock error. Here, the pseudorange is the distance from the GPS receiver to each GPS satellite and is measured as the sum of a correct distance and a clock error caused by a gain of the GPS receiver clock. Thus, the GPS receiver determines the pseudorange by multiplying a signal transit time by the speed of light, where the signal transit time is obtained by subtracting the signal transmission time at each GPS satellite from the signal reception time at the GPS receiver. The thus calculated pseudoranges and positions of the GPS satellites at the signal transmission time that can be obtained by receiving ephemeris parameters of the navigation data, the position of the measurement point in a three dimensional space can be calculated. A typical example of such GPS position calculation method is disclosed in International Patent Application Publication No. WO 2005/017552 (corresponding to US 2006/0116820 A1).

The ephemeris parameters of the navigation data used in the GPS are, as shown here in FIG. 8, determined based on observation data obtained by monitoring stations (GPS receivers 105 to 109) located on the earth as five reference points with positional data already known. Since the position of a measurement point is calculated from the position of the GPS satellite 101, the position of the GPS satellite is very important and hence is updated about every two hours. The GPS receiver located on a measurement point calculates the current position the GPS satellite on a three-dimensional basis from the position of the GPS satellite 101 at the signal transmission time and the pseudorange.

In the case where the aforesaid clock error Δt is small, the GPS receiver should be able to calculate the position of a measurement point by using three variables x, y and z acquired from signals from the GPS satellites. However, because the clock error Δt is significantly large, a technique has been proposed in which the clock error Δt is used as a fourth variable additional to the three variables x, y, z, in order to detect the current position of the measurement point. For example, as shown here in FIG. 9, the GPS receiver 105 needs to receive navigation data from at least four GPS satellites 101-104.

According to another known GPS position calculation method, such as shown in Japanese Patent No. 3524018 (corresponding to JP 2001-4733 A), navigation data from more than four GPS satellites are used. All of the known techniques specified above have a limited positioning accuracy due to a large error involved in the calculated pseudorange. In view of this, various methods have been proposed in order to improve the positioning accuracy. One example of such proposed methods is shown in FIG. 10, where differential data obtained as the results of positioning at a reference base station (stationary station receiver) 110 on the earth are used to estimate errors involved in the pseudoranges. The proposed methods still have drawbacks that the entire system is rendered complicated and the calculation time and cost increase.

It may be considered that a clock error and an orbit error of each GPS satellite, an ionosphere delay and a troposphere delay during signal propagation, a change in the antenna phase center, a clock error and a multipath cancellation of the GPS receiver cause errors. The clock errors include an error caused by the clock itself, and a time delay caused by a so-called “relativistic effect” according to the theory of specific relativity or general relativity. Furthermore, random noise may be considered as an error-inducing factor.

To limit the error effects, various attempts have been made, but no decisive measures have so far been found and a process of trial and error is still continued. Under these circumstances, a certain method has been employed wherein pseudoranges are estimated either from data acquired from more than four GPS satellites, or from the results of positioning at a reference base station on the earth. Furthermore, as evidenced by a graph shown here in FIG. 11, the positioning error has an elevation-angle-dependent property. In view of this elevation-angle-dependent property, it is a general way to preferentially use data from a GPS satellite of large elevation angle where the positioning error is relatively small. However, due to the positioning error, the pseudorange calculation method and system are rendered complicated.

### SUMMARY OF THE INVENTION

It is accordingly an object of the present invention to provide GPS position calculating method and apparatus, which are able to calculate pseudoranges in a simple and accurate manner, thereby improving the detection accuracy of the position of a measurement point or the position of a GPS satellite at a signal transmission time.

According to a first aspect of the present invention, there is provided a position calculating method using a global positioning system (GPS) for determining the position of a measurement point on the horizon by a computing unit on the basis of signals received at a receiver on the measurement point from at least three GPS satellites, the method comprising: a first step of acquiring orbit information from navigation data contained in the signals received at the receiver, said orbit information including a first position, clock time and orbital speed of each of the GPS satellites at a time when each GPS satellite transmits a respective signal; a second step of calculating a second position of each GPS satellite at a time when the signal from each GPS satellite is received at the receiver, from the orbital speed and the clock time that are acquired at the first step; a third step of calculating a range of a line segment connecting the second position of each GPS satellite calculated at the second step with a position of the measurement point, from a time difference obtained by subtracting the signal transmission time from the signal reception time; and a fourth step of calculating the position of the measurement point from the respective ranges of the line segments calculated at the third step each connecting a respective one of the second positions of the at least three GPS satellites with the position of the measurement point.

With the position calculating method thus arranged, the position of each GPS satellite at the signal reception time is calculated from the signal transmission time and orbital speed of each GPS satellite that are acquired from the GPS satellite signal, and a time difference obtained by subtracting the transmission time from the reception time of the same GPS satellite signal. And, the distance or range connecting the thus calculated GPS satellite position at signal reception time with the position of the measurement point is calculated as a pseudorange. The distance or pseudorange is obtained by multiplying the time difference by the speed of light. Use of the pseudorange, which is originated from the GPS satellite position at signal reception time, enables highly accurate pseudorange calculation, as compared to the conventional method in which the distance from the measurement point to the position of the GPS satellite at signal transmission time is used as a pseudorange.

Furthermore, because the position of the measurement point is determined on the basis of information about the position of each of the at least three GPS satellites obtained at signal reception time and the calculated pseudorange to each GPS satellite position at signal reception time, the position detecting accuracy at the measurement point greatly increases and can eliminate the use of an increased number of GPS satellites. Furthermore, the position calculating method of the present invention does not require reference positioning data to be supplied from a fixed base station on the earth and, hence, the pseudorange calculation procedure is relatively simple.

According to a second aspect of the present invention, there is provided a position calculating apparatus using a global positioning system (GPS) for determining the position of a measurement point on the horizon by a position calculating unit on the basis of signals received at a receiver on the measurement point from at least three GPS satellites, the apparatus comprising: a navigation data acquiring section for acquiring orbit information from navigation data contained in the signals received at the receiver, said orbit information including a first position, clock time and orbital speed of each of the GPS satellites at a time when each GPS satellite transmits a respective signal; a pseudorange calculating section for calculating a second position of each GPS satellite at a time when the signal from each GPS satellite is received at the receiver, from the orbital speed and clock time acquired by the navigation data acquiring section, and a time difference obtained by subtracting the acquired signal transmission time from the signal reception time, and further calculating a range of a first line segment connecting the calculated second position of each GPS satellite with a position of the measurement point; and a position calculating section for calculating the position of the measurement point from the respective ranges of the first line segments calculated by the pseudorange calculating section each connecting a respective one of the second positions of the at least three GPS satellites with the position of the measurement point.

Preferably, the pseudorange calculating section further calculates a range of a second line segment connecting the first position of each GPS satellite with the position of the measurement point, from the position of the measurement point, and outputs the calculated range of the second line segment to the position calculating section as a pseudorange. This arrangement will increase the calculation quantity but can provide an degree of increased calculation accuracy and reduced calculation load, and allows the use of existing GPS positioning systems because pseudorange calculation is performed without using the satellite elevation angle.

According to a third aspect of the present invention, there is provided a GPS (global positioning system) satellite position calculating method wherein signals transmitted from at least three GPS satellites are received by a receiver at a reference point on the horizon, and the position of each respective GPS satellite at a reception time when the signal from each GPS satellite is received at the receiver is calculated by a computing unit on the basis of a known position of the reference point, the method comprising: a first step of acquiring orbit information from the signals received at the receiver, the orbit information including a transmission time of each signal, and an orbital speed of each GPS satellite; a second step of calculating a position of each GPS satellite at the reception time, from a time difference between the reception time and the transmission time and the acquired orbital speed; a third step of calculating a distance from the position of the reference point to the position of each GPS satellite at the reception time; and a fourth step of calculating the position of each respective GPS satellite at the reception time, from the calculated distances from the position of the reference point to the respective positions of the at least three GPS satellite at the reception time.

According to a fourth aspect of the present invention, there is provided a GPS (global positioning system) satellite position calculating apparatus including a receiver for receiving signals transmitted from at least three GPS satellites, and a computing unit for calculating the position of each respective GPS satellite at a reception time when the signal from each GPS satellite is received at the receiver, on the basis of a known position of the reference point, the apparatus comprising: a navigation data acquiring section for acquiring orbit information from the signals received at the receiver, the orbit information including a transmission time of each signal, and an orbital speed of each GPS satellite; a pseudorange calculating section for calculating a position of each GPS satellite at the reception time, from a time difference between the reception time and the transmission time and the acquired orbital speed, and further calculating a distance from the position of the reference point to the calculated position of each GPS satellite at the reception time; and a satellite position calculating section for calculating the position of each respective GPS satellite at the reception time, from the calculated distances from the position of the reference point to the respective positions of the at least three GPS satellite at the reception time.

In the GPS position calculating method and apparatus described above, the distance from the position of each GPS satellite at signal reception time to the position of the reference point is used as a pseudorange. By thus using the pseudorange originated from the GPS satellite position at signal reception time, it is possible to simplify the pseudorange calculation procedure, to increase calculation accuracy, and to eventually improve the GPS satellite position detecting accuracy, as compared the conventional method in which the distance from the GPS satellite position at signal transmission time to the reference point is used as a pseudorange.

Furthermore, because the position of the measurement point is determined on the basis of information about the position of each of the at least three GPS satellites obtained at signal reception time and the calculated pseudorange to each GPS satellite position at signal reception time, the position detecting accuracy at the measurement point greatly increases and can eliminate the use of an increased number of GPS satellites. Furthermore, the position calculating method of the present invention does not require reference positioning data to be supplied from a fixed base station on the earth and, hence, the pseudorange calculation procedure is relatively simple.

### BRIEF DESCRIPTION OF THE DRAWINGS

Certain preferred embodiments of the present invention will hereinafter be described in detail, by way of example only, with reference to the accompanying drawings, in which:

FIG. 1 is a block diagram showing a general configuration of a GPS position calculating apparatus embodying the present invention;

FIGS. 2A through 2E are vector diagrams showing the basic concept of a GPS position calculating method of the present invention by using two inertial coordinate systems;

FIG. 3 is a vector diagram showing the relationship between angles of a GPS satellite and a measurement point in the inertial coordinate systems shown in FIGS. 2A through 2E;

FIG. 4 is a flowchart showing a sequence of operations of the GPS position calculating apparatus;

FIGS. 5A and 5B are vector diagrams showing the basic concept of the GPS position calculating method of the invention by using rotational inertial coordinate systems;

FIG. 6 is a flowchart showing a sequence of operations of the GPS position calculating apparatus when the apparatus is used as a GPS satellite position calculating apparatus according to another embodiment of the present invention;

FIG. 7 is a flowchart showing a sequence of operations of the GPS position calculating apparatus when the apparatus is used as a GPS satellite position calculating apparatus according to still another embodiment of the present invention;

FIG. 8 is a diagrammatical view showing a conventional GPS satellite position calculating method;

FIG. 9 is a diagrammatical view showing a conventional GPS position calculating method;

FIG. 10 a diagrammatical view showing a conventional GPS position calculating method using differential data; and

FIG. 11 is a graph showing the relationship between the satellite elevation angle and the positioning error involved in the GPS position calculation.

### DETAILED DESCRIPTION OF THE PREFERRED EMBODIMENTS

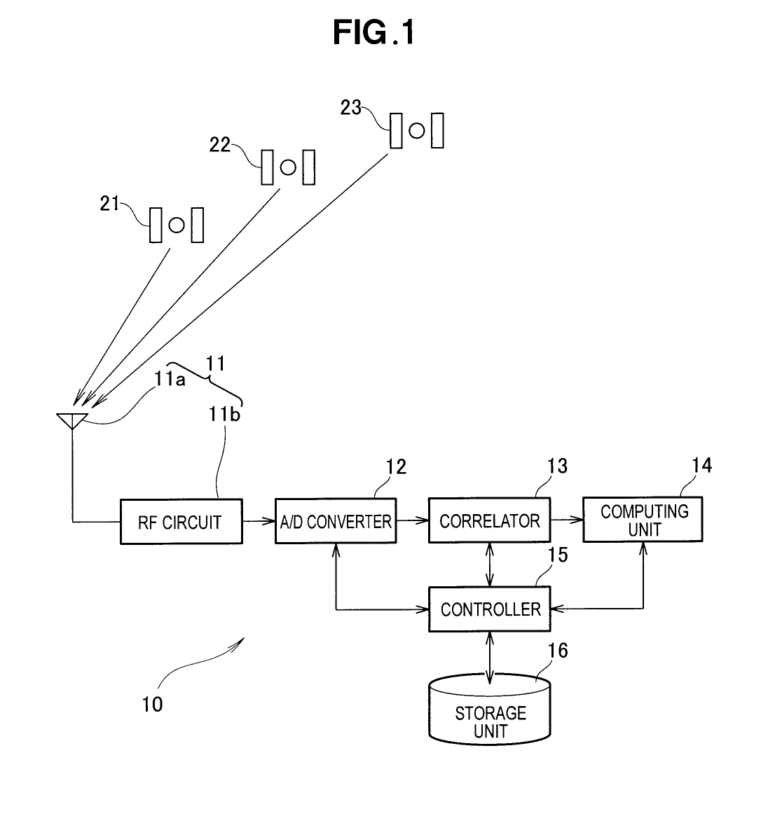

A first embodiment of the present invention will be described with reference to the accompanying sheets of drawings. Referring first to FIG. 1, there is shown in block diagram a GPS position calculating apparatus 10 according to the first embodiment of the present invention. The GPS position calculating apparatus 10 generally comprises a receiver 11, an analog-to-digital converter (A/D converter) 12, a correlator 13, a computing unit 14, a controller 15, and a storage unit 16. The receiver 11 includes an antenna 11a and a high-frequency circuit 11b. The high-frequency circuit 11b will be hereinafter referred to as “radio frequency (RF) circuit”.

The RF circuit 11b receives via the antenna 11a signals (radio waves) transmitted from at least three GPS satellites 21, 22 and 23 and down-converts the received GPS satellite signals into signals of intermediate frequency (IF) band. The IF band signals are then output from the RF circuit 11b to the A/D converter 12.

The A/D converter 12 converts the analog signals output from the RF circuit 11b into digital signals and outputs the thus converted digital signals to the correlator 13 and the controller 15.

The correlator 13 detects a reception frequency on the basis of the input digital signals. More particularly, the correlator 13 demodulates the digital signals output from the A/D converter 12 from coarse and acquisition (C/A) codes of the GPS satellites and computes radio wave transit lags or delays.

The controller 15 has a function to acquire navigation data from the digital signals output from the A/D converter 12 and output the acquired navigation data to the computing unit 14, and also has a function to issue a position calculation order or command to the computing unit 14, instructing the computing unit 14 to perform pseudorange calculations and position calculations. The navigation data used for the GPS position calculations includes almanac data and ephemeris data.

The almanac data contains parameters indicative of coarse positions of all GPS satellites. The almanac date is available for about two weeks. This time limit is provided in view of a time-dependent orbital shift of each GPS satellite and corresponds to an available period of the almanac data. The ephemeris data contains parameters providing the precise orbit information for each GPS satellite and is used when the controller 15 executes position calculation for each GPS satellite. The ephemeris data is available for about two hours. Precise ephemeris data provides more detailed orbit information at every updating event.

The computing unit 14 achieves a series of operations under program control by the controller 15, wherein the operations starts at a first step and ends at a forth step, as will be discussed below.

At the first step of operation, the computing unit 14 acquires orbit information of the GPS satellites 21, 22, 23 from navigation data contained in the signals received by the RF circuit 11b. The orbit information includes a position A1, A2, A3 (collectively designated as “A”), clock time tb1, tb2, b3 (collectively designated as “tb”), and orbital speed v1, v2, v3 (collectively designated as “v”) of each of the GPS satellites 21, 22, 23 at a transmission time when each GPS satellite 21, 22, 23 transmits a respective signal.

At a second step of operation, the computing unit 14 calculates a position B1, B2, B3 (collectively designated as “B”) of each GPS satellite 21, 22, 23 at a reception time “tr” when the signal from each GPS satellite is received at the receiver 11 of the GPS position calculating apparatus 10 located at a measurement point, by using the orbital speed v and the clock time (signal transmission time) tb that are acquired at the first step.

At a third step of operation, the computing unit 14 calculates a distance or range ct1, ct2, ct3 (collectively designated as “ct”) of a line segment connecting the position B of each GPS satellite 21, 22, 23 with the position O of the measurement point, from a time difference t obtained by subtracting the transmission time tb from the reception time tr as (t=tr−tb).

At a fourth step of operation, the computing unit 14 calculates the position O of the measurement point from the respective ranges ct (ct1, ct2, ct3) of the line segments calculated at the third step each connecting a respective one of the positions B of the at least three GPS satellites 21, 22, 23 with the position O of the measurement point.

The first to fourth operation steps are programmed in advance and stored in the storage unit 16. The controller 15 is constituted by, for example, a microprocessor, and by sequentially retrieving and executing the program stored in the storage unit 16, the controller 15 urges the computing unit 14 to perform calculation of the ranges (pseudoranges) ct and calculation of the position O of the measurement point in succession.

The storage unit 16 also stores other pieces of information concerning the center position and radius “r” of the earth, frequencies of the GPS satellites 21, 22, 23, and the speed “c” of light that are referenced by the controller 15.

Operation for calculating the angles α, pseudoranges cs and the position O of the measurement point will be described as being achieved by the computing unit 14 under the control of the control unit 15. However, the control unit 15 may undertake such calculations in place of the computing unit 14.

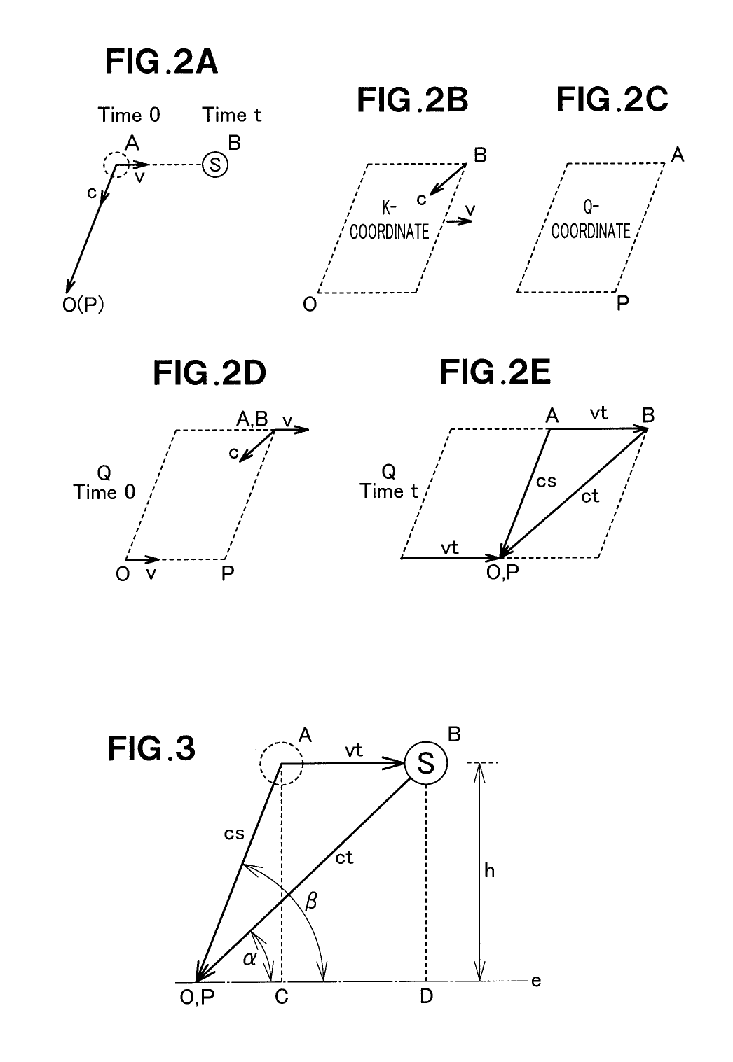

Before starting description about operation of the GPS position calculating apparatus 10, the basic concept of the GPS position calculation will be briefly described with reference to FIGS. 2A to 2E and FIG. 3.

Description will be given on the assumption that as shown in FIG. 2A, at a point of time 0 (Time=0), a signal transmitted from a GPS satellite located at a position A is received by the GPS position calculating apparatus 10 located at a measurement point O. When the GPS position calculation apparatus 10 receives the GPS satellite signal, the GPS satellite has already moved from the position A to a position B. For convenience of explanation, the position A will be hereinafter referred to as “reference position” of the GPS satellite, and the position B as “current position” of the GPS satellite. Reference character S in FIG. 2A denotes the GPS satellite.

The foregoing phenomenon will be described using a K-coordinate (coordinate of the GPS satellite 5) indicated by a dotted-lined quadrangle (parallelogram) shown in FIG. 2B and a Q-coordinate (coordinate on the earth) indicated by a dotted-lined quadrangle (parallelogram) shown in FIG. 2C.

As shown in FIG. 2B, the measurement point O and the position B of the GPS satellite are located diagonally at opposing corners of the K-coordinate. Similarly, as shown in FIG. 2C, the position A of the GPS satellite is located at the right end of a topside of the Q-coordinate. The K-coordinate is moving rightward with a speed v relative to the Q-coordinate. Here, the GPS satellite S is always present at the position B in the K-coordinate. These two inertial coordinate systems (in which the inertial law can apply) overlap each other at the point of time 0 (Time=0), as shown in FIG. 2D.

In FIG. 2D, the reference position A and the current position B overlap each other. In this condition, if the GPS satellite transmits a signal at a point of time (Time=0) with a radio wave propagation speed (the speed of light, “c”) from the position A toward the measurement point O in the K-inertial coordinate system, the signal will reach the measurement point O after a lapse of a predetermined time t (Time=t). The distance or range from the position B to the measurement point O is set to be “ct”, and the distance or range from the measurement point O to a point P is set to be “vt”.

After a lapse of the predetermined time t from the transmission time (Time=0) of the GPS satellite signal, i.e., at the point of time (Time=t), the measurement point O and the point P overlap each other as shown in FIG. 2E. In FIG. 2E, the signal transmitted from the position B by the GPS satellite reaches the measurement point O. In this instance, it appears for the GPS position calculating apparatus 10 located in the Q-inertial coordinate system that the signal transmitted from the position A has reached the point P. Since the signal in the Q-inertial coordinate system also travels with the speed of light, the distance or range from the position A to the point P is given as “cs”. Here, it is to be noted that the distance or range ct, which is obtained by multiplying a time difference between a transmission time of signal at each GPS satellite and a reception time of the same signal at the measurement point (receiver 11) by the speed of light, represents a distance between the GPS satellite S and the measurement point at the time when the measurement point received the signal.

The relationship between the signal and the motion in the inertial coordinate systems is shown in combination with the angle, such as shown in FIG. 3. In FIG. 3, an elevation angle of the GPS satellite at the transmission time of the signal (i.e., an angle of a line segment connecting the reference position A of the GPS satellite S with the position O of the measurement point relative to the horizon e) is designated by β, and an elevation angle of the GPS satellite S at the reception time of the same signal at the GPS position calculating apparatus 10 (i.e., an angle of a line segment connecting the current position B of the GPS satellite S with the position O of the measurement point relative to the horizon e) is designated by α. The GPS satellite S has an altitude h. The altitude h, orbital speed v and clock time t of the satellite are determined by navigation data transmitted from the GPS satellite.

As shown in FIG. 3, the distance or range cs can be expressed by the following equation (1) using the Pythagorean theorem as applied to a right triangle ΔAOC.

cs=\sqrt{(ct×cos α−vt)²+(ct×sin α)²} (1)

Here, the term ct×sin α is equivalent to an altitude h. By substituting the equation (1) into the following equation: ct·sin α=cs·sin α which is a length relational expression of the two right triangles ΔAOC and ΔOBD, we obtain the following equation (2). Further modifying the equation (2) develops the following equation (3), which is an angle relational expression. Considering the above-identified length relational expression in conjunction with the equation (3), we obtain the following time-variable expression (4).

$$\begin{matrix}ct \times sin α = \sqrt{{( ct \times cos α - vt )}^{2} + {( ct \times sin α )}^{2}} \times sin β & ( 2 ) \\ {sin}^{2} α = \{ {( cos \partial - \frac{v}{c} )}^{2} + {sin}^{2} α \} {sin}^{2} β & ( 3 ) \\ \frac{s}{t} = \sqrt{{( cos α - \frac{v}{c} )}^{2} + {sin}^{2} α} & ( 4 )\end{matrix}$$

According to the angle relational expression (3), the GPS position calculating apparatus 10 located at the measurement point can calculate an angle α of the line segment connecting the current position B of the GPS satellite S with the position O of the measurement point relative to the horizon e and an angle β of the line segment connecting the reference position A of the GPS satellite S with the position O of the measurement point relative to the horizon. Form the angle α calculated using the expression (3), the distance or range cs from the position O of the measurement point to the GPS satellite S at the signal reception time is obtained by the following equation (5).

$$cs = \sqrt{{( cos α - \frac{v}{c} )}^{2} + {sin}^{2} α} \times ct \qquad ( 5 )$$

In the angle relational expression (3), if β=π/2, we obtain α=cos⁻¹(v/c). In this instance, the time-variable expression (4) is modified into the following arithmetic expression (6).

$$\frac{s}{t} = \sqrt{1 - \frac{{v}^{2}}{{c}^{2}}} \qquad ( 6 )$$

The arithmetic expression (6) corresponds to a time-delay according to the theory of special relativity. This means that the relationship between the angle α and the angle β cannot be considered by the theory of special relativity. In view of this, calculation of the pseudorange has conventionally been performed on the basis of such a signal transmitting from a GPS satellite having a large elevation angle because the positioning error tends to increase as the satellite elevation angle becomes small, as shown in FIG. 11. This tendency is similar to that of a zenith angle error, which has been reported heretofore as an error. The zenith angle error increases at a rate of about 1/cos with an increase in the zenith angle.

According to the embodiment of the present invention, the relationship between the angle α and the angle β is reflected on calculation of the pseudorange so that the pseudorange can be calculated with high accuracy without depending on the zenith angle. Furthermore, there is no need to delay the clock in the GPS satellite relative to the clock of the receiver in consideration of the theory of special relativity. The GPS satellite clock and the receiver clock need to be synchronized with each other. The base concept of the pseudorange calculation involving relatively moving two inertial coordinate systems has thus been described.

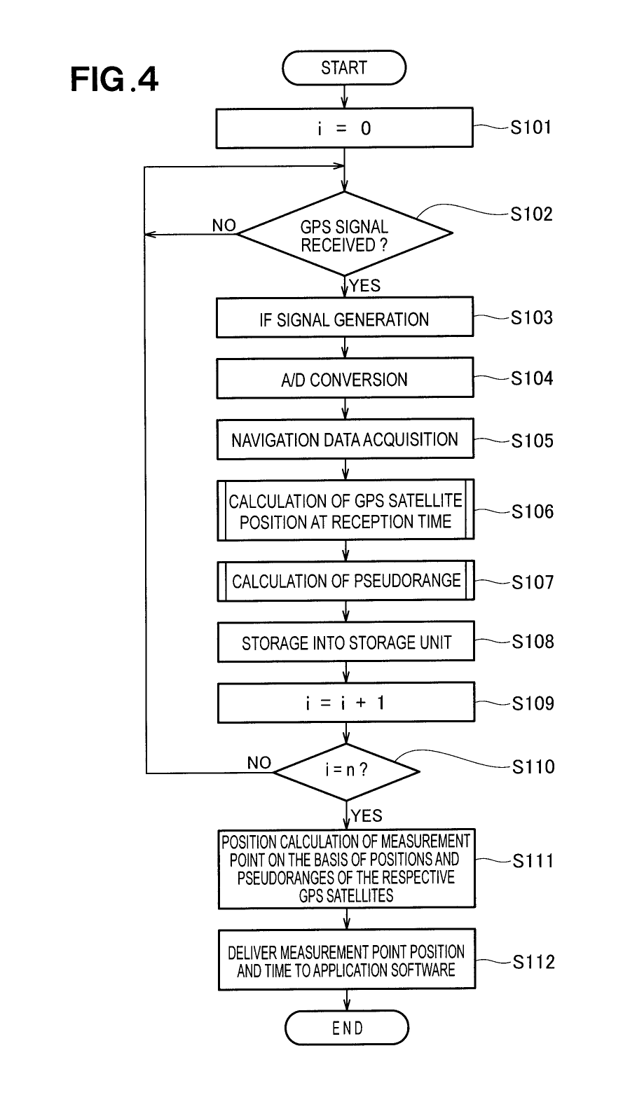

Operation of the GPS position calculating apparatus 10 according to the first embodiment of the present invention shown in FIG. 1 will be described in detail with reference to a flowchart shown in FIG. 4. The flowchart shows a sequence of operations to be executed by the controller 15.

At step S101, the controller 15 sets a count value i of a counter assigned to the program to “0”. The counter counts the number of target GPS satellites from which signals are to be received. In the illustrated embodiment, the number “n” of target GPS satellites is three, and these three target Satellites 21, 22 and 23 are used for determining the position of a measurement point.

At step S102, the controller 15 determines as to whether a high-frequency analog signal transmitted from the first GPS satellite 21 has been received by the RF circuit 11b. If an affirmative determination is made (YES) at step S102, the control process goes on to step S103, where the RF circuits 11b down-converts the high-frequency analog signal into an IF analog signal and outputs the IF analog signal to the A/D converter 12.

Subsequently, the controller 15 issues a signal conversion order to the A/D converter 12, whereupon at step S104, the A/D converter converts the IF analog signal to a digital signal and outputs the digital signal to the correlator 13 and the controller 15. Subsequently, at step S105 the controller 15 acquires navigation data (orbital speed v, and transmission time tb) from the digital signal and outputs the acquired navigation data to the computing unit 14. At the same time, the controller 15 issues a pseudorange calculation order to the computing unit 14.

At step S106, upon receipt of the pseudorange calculation order from the controller 15, the computing unit 14 starts calculating a position B of the GPS satellite 21 at a reception time tr of the signal at a measurement point (GPS position calculating apparatus 10) by using the orbital speed v acquired at step S105 and a time difference t obtained by subtracting the transmission time tb from the reception time tr as (t=tr−tb).

Subsequently, at step 107, the computing unit 14 multiplies the dime difference (t=tr−tb) by the speed of light “c” to thereby calculate a distance or range ct between the GPS satellite S and the measurement point at the reception time of the signal at the measurement point. The computing unit 14 outputs the result of calculation (calculated range ct) to the controller 15.

Upon receipt of the pseudorange es from the computing unit 14, the controller 15 first stores the calculated pseudorange es in a predetermined storage area of the storage unit 16 at step S108 and then increments the count value i of the counter by one at step S109.

Subsequently, at step S110, the controller 15 compares the count value i of the counter with the number “n” of target GPS satellites. If the count value i is less the number “n” of target GPS satellites (i<n), the control process returns to step S102 (GPS signal reception judgment process) and, subsequently, those processing steps S102 to S109 which are already discussed above with respect to the signal from the target GPS satellite 21 will be repeated for each of the remaining target GPS satellites 22, 23.

When it is confirmed that the count value i has reached the number “n” of target GPS satellites (i=n) at step S110, the controller 15 issues a position calculation order to the computing unit 14.

At step S111, upon receipt of the position calculation order from the controller 15, the computing unit 14 performs calculation of a position of the measurement point on the basis of the acquired three-dimensional positions S (x, y, z) of the respective GPS satellites 21, 22, 23 and the calculated pseudoranges ct1, ct2, ct3 of the respective GPS satellites 21, 22, 23, and outputs the result of calculation (calculated position O of the measurement point) to the controller 15.

When achieving the calculation of a three-dimensional position O (x, y, z) of the measurement point on the basis of the respective positions S1, S2, S3 of the GPS satellites and the calculated pseudoranges ct1, ct2, ct3 of the GPS satellites, the computing unit 14 solves the following equation (7):

$$\{ \begin{matrix}ct 1 = \sqrt{{( x 1 - x )}^{2} + {( y 1 - y )}^{2} + {( z 1 - z )}^{2}} \\ ct 2 = \sqrt{{( x 2 - x )}^{2} + {( y 2 - y )}^{2} + {( z 2 - z )}^{2}} \\ ct 3 = \sqrt{{( x 3 - x )}^{2} + {( y 3 - y )}^{2} + {( z 3 - z )}^{2}}\end{matrix} \qquad ( 7 )$$

where ct1 is the range of the second line segment connecting the first position of the first GPS satellite with the position of the measurement point, ct2 is the range of the second line segment connecting the first position of the second GPS satellite with the position of the measurement point, ct3 is the range of the second line segment connecting the first position of the third GPS satellite with the position of the measurement point, (x, y, z) is the position coordinate of the receiver, (x1, y1, z1) is the position coordinate of the first GPS satellite, (x2, y2, z2) is the position coordinate of the second GPS satellite, and (x3, y3, z3) is the position coordinate of the third GPS satellite.

A solution to the equation (7) that is a system equation will give a three-dimensional position O (x, y, z) of the measurement point.

Finally, at step S112, the controller 15 delivers the calculated position of the measurement point and time to a piece of application software, such as routing assistance software for car navigation and terminates the afore-mentioned series of operations achieved to determine the position of the measurement point.

According to the GPS position calculating apparatus 10 according to the first embodiment of the present invention, information about an orbital speed v and transmission time tb, which is acquired from navigation data contained in signals transmitted from at least three GPS satellites 21, 22, 23, is used, and the position B of each GPS satellites at a reception time tr when the signal from each GPS satellite is received at the measurement point (i.e., the receiver 11) is calculated on the basis of a time difference t obtained as (t=tr−tb).

Subsequently, a range of a line segment connecting the calculated position B of each GPS satellite with a position O of the measurement point is calculated.

For calculation of the range (pseudorange) ct, it is necessary that the position B of each GPS satellite at the signal reception time be determined in advance by calculation. However, use of the pseudorange ct enables pseudorange calculation with extremely high accuracy as compared to the conventional method in which the distance between the GPS satellite position and the measurement point at the signal transmission time is used as a pseudorange.

Furthermore, because the position of the measurement point is determined by calculation on the basis of information about the position of each GPS satellite obtained at signal reception time and the calculated pseudorange ct to each GPS satellite position at signal reception time, the position detecting accuracy at the measurement point greatly increases and can eliminate the use of an increased number of GPS satellites. Additionally, the position calculating method of the present invention does not require reference positioning data to be supplied from a fixed base station on the earth and, hence, the pseudorange calculation procedure is relatively simple.

Although in the illustrated embodiment, the range ct of the line segment connecting the calculated GPS position B and the position O of the measurement point is used as a pseudorange, it is also possible according to the invention to further calculate from the determined position O of the measurement position, a range cs of a second ling segment connecting the position A of each GPS satellite and the position O of the measurement point at the signal transmission time, and to use the calculated range cs of the second line segment as a pseudorange. This arrangement will increase the calculation quantity but can provide an increased degree of calculation accuracy and reduced calculation load, and allows the use of existing GPS positioning systems because pseudorange calculation is performed without using the satellite elevation angle.

In the flowchart shown in FIG. 4, step S105 corresponds to a navigation data acquiring section, which forms a part of the GPS position calculating apparatus 10 and which is configured to acquire orbit information from navigation data contained in the signals received at the receiver 11, wherein the navigation data includes a position A, clock time tb, and orbital speed v of each of the at least three GPS satellites at a transmission time when each GPS satellite transmits a respective signal.

Steps S106 and S107 together correspond to a pseudorange calculating section, which forms a part of the GPS position calculating apparatus 10 and which is configured to calculate a position B of each GPS satellite at a time when the signal from each GPS satellite is received at the measurement point (receiver 11), from the orbital speed and clock time acquired by the navigation data acquiring section, and a time difference (t=tr−tb) obtained by subtracting the acquired signal transmission time tb from the signal reception time tr, and to further calculate a range ct of a line segment connecting the calculated position B of each GPS satellite with a position O of the measurement point.

Step S111 corresponds to a position calculating section, which forms a part of the GPS position calculating apparatus 10 and which is configured to calculate the position O of the measurement point from the respective ranges ct (ct1, ct2, ct3) of the first segments each connecting a respective one of the second positions B (B1, B2, B3) of the at least three GPS satellites 21, 22, 23 with the position O of the measurement point.

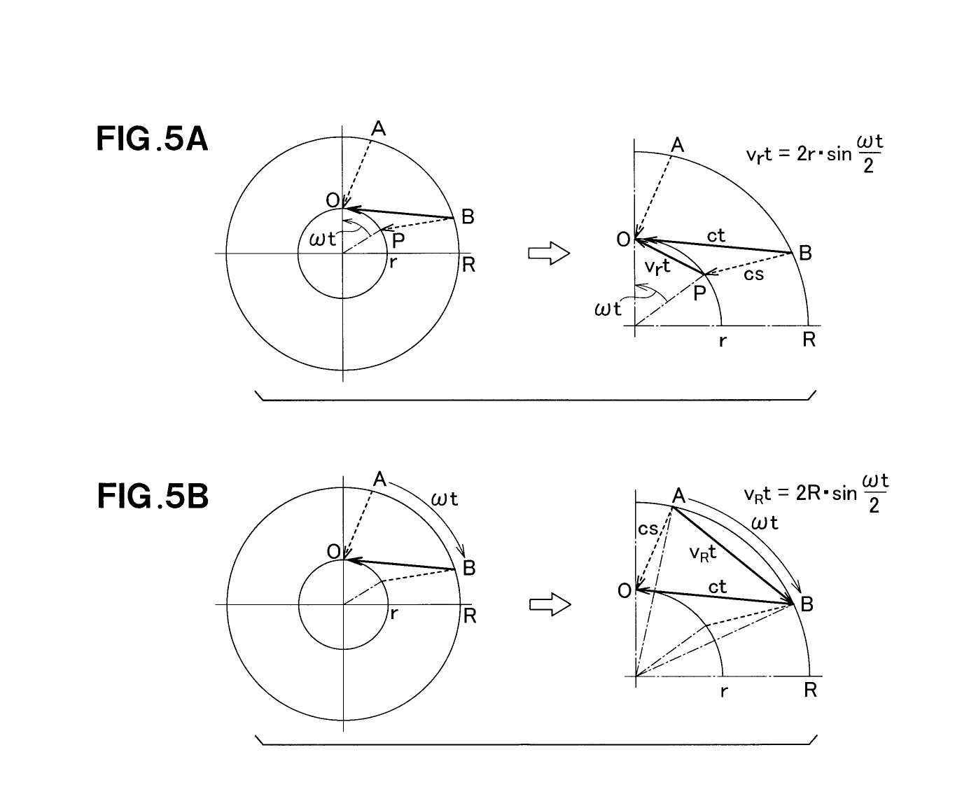

In the embodiment described above, two inertial coordinate systems are used to calculate the pseudoranges. However, because relative circular orbits can represent the relationship between each of the GPS satellites 21-23 and the measurement point on the earth, the inertial coordinate systems are actually rotational inertial coordinate systems. The relationship between the rotational movement in the rotational inertial coordinate systems and the signal transmission will be described with reference to FIGS. 5A and 5B.

FIG. 5A shows a relationship between the rotational movement and the signal transmission when viewed from the K-coordinate, and FIG. 5B shows a relationship between the rotational movement and the signal transmission when viewed from the Q-coordinate. As shown in FIG. 5A, when viewed from the K-coordinate, the GPS position calculating apparatus 10 located at the measurement point on the earth moves at time t from a position P to a position O by an angle ωt. On the other hand, as shown in FIG. 5B, when viewed from the Q-coordinate, the GPS satellite moves at time t from a position A to a position B by an angle ωt.

For the K-coordinate, the relationship between the movement and the time in the rotational movement can be calculated by the following expression (8). Similarly, for the Q-coordinate, the relationship between the movement and the time in the rotational movement can be calculated by the following expression (9):

$$vrt = 2 r sin \frac{ω t}{2} \qquad ( 8 )$$

where vrt is the speed of movement of the measurement point (GPS position calculating apparatus 10) on the earth at a point of time t, w is the relative angular velocity between the measurement point and each GPS satellite, and r is the radius of the earth.

$$vRt = 2 R sin \frac{ω t}{2} \qquad ( 9 )$$

where vRt is the speed of movement of each GPS satellite at t, w is the relative angular velocity between the measurement point and each GPS satellite, and R is the radius of the orbit of each GPS satellite.

Even for satellites having elliptic or more complicated orbits, the relationship between ct, cs and vrt does not change. It is therefore possible to calculate the pseudorange cs by drawing a triangular vector diagram having three vector components ct, cs, vrt. In another embodiment where the movement-time relationship in a rotational movement, such as shown in FIGS. 5A and 5B, is taken into consideration, the GPS position calculating apparatus 10 is able to perform calculation of the pseudorange ct by achieving the same operation as done in the first embodiment excepting that the computing unit 14 calculates a relationship between the movement and the time in the rotational movement on the basis of the foregoing expressions (8) and (9).

As thus far described, the relationship between the GPS satellites 21-23 having circular orbits and the measurement point on the earth can be expressed by rotational inertial coordinate systems, and by calculating a relationship between the rotational movement and the time using the foregoing expressions (8) and (9), a pseudorange ct can be calculated accurately without involving any error even when the GPS satellites are moving in elliptic or more complicated orbits.

The GPS position calculating method according to the present invention is such a GPS position calculating method, which performs position detection of a measurement point (GPS point calculating apparatus 10) on the horizon e by receiving signals transmitted from at least three GPS satellites 21-23, as shown in FIG. 1.

The GPS position calculating method includes first to fourth steps as shown in FIG. 4, where the first step, as done at step S105, acquires orbit information from navigation data contained in the signals received at the receiver, wherein the orbit information includes a first position A, clock time tb, and orbital speed v of each GPS satellite at a time when each GPS satellite transmits a respective signal. Subsequently, the second step, as done at step S106, calculates a second position B of each GPS satellite at a time tr when the signal from each GPS satellite is received at the measurement point (receiver 11), from the orbital speed v and the clock time (transmission time) tb that are acquired at the first step.

The third step, as done at step S107, calculates a range ct of a line segment connecting the second position B of each GPS satellite calculated at the second step with a position O of the measurement point, from a time difference (t=tr−tb) obtained by subtracting the signal transmission time tb from the signal reception time tr. The fourth step, as done at step S111, calculates the position O of the measurement point from the ranges ct (ct1-ct3) of the line segments each connecting a respective one of the second positions B (B1-B3) of the at least three GPS satellites 21-23 with the position O of the measurement point that are calculated by the third step.

The GPS position calculating method of the present invention makes it possible to perform position detection of a measurement point with extremely high accuracy. According to the GPS position calculating method of the present invention, the distance or range ct, which is obtained by multiplying the time difference (t=tr−tb) between a transmission time tr of signal at each GPS satellite and a reception time tr of the same signal at the measurement point (receiver 11) by the speed of light “c”, represents a distance between the GPS satellite and the measurement point at the time when the measurement point received the signal. Use of the range (pseudorange) ct, which is originated from the GPS satellite position B at signal reception time tr, enables highly accurate pseudorange calculation, as compared to the conventional method in which the distance from the measurement point to the position of the GPS satellite at signal transmission time is used as a pseudorange.

Furthermore, because the position O of the measurement point is determined on the basis of information about the position of each of the at least three GPS satellites obtained at signal reception time and the calculated pseudorange to each GPS satellite position at signal reception time, the position detecting accuracy at the measurement point greatly increases and can eliminate the use of an increased number of GPS satellites. Additionally, the position calculating method of the present invention does not require reference positioning data to be supplied from a fixed base station on the earth and, hence, the pseudorange calculation procedure is relatively simple. Furthermore, regardless of the shape of satellite orbit, calculation of the pseudorange can be achieved accurately without involving any error.

The GPS position calculating apparatus 10 of the configuration shown in FIG. 1 is also effectively operable when used as a GPS position calculating apparatus for calculating the position of the GPS satellites at signal transmission time. In this application, the measurement point in the first embodiment shown in FIGS. 2 and 4 constitutes a reference point on the horizon, which has a known position O. A typical example of such reference point is a fixed receiver station on the earth. In a second embodiment of the invention, where the GPS position calculating apparatus 10 is used as a GPS satellite position calculating apparatus, the computing unit 14 achieves a series of operations under program control by the controller 15, wherein the operations starts at a first step and ends at a forth step, as will be discussed below.

At the first step of operation, the computing unit 14 acquires orbit information of the GPS satellites 21, 22, 23 from navigation data contained in the signals received by the RF circuit 11b. The orbit information includes a position A1, A2, A3 (collectively designated as “A”), clock time tb1, tb2, b3 (collectively designated as “tb”), orbital speed v1, v2, v3 (collectively designated as “v”), and altitude h1, h2, h3 (collectively designated as “h”) of each of the GPS satellites 21, 22, 23 at a transmission time when each GPS satellite 21, 22, 23 transmits a respective signal.

At a second step of operation, the computing unit 14 calculates a position B1, B2, B3 (collectively designated as “B”) of each respective GPS satellites 21, 22, 23 at a reception time “tr” when the signal from each GPS satellite is received at the receiver 11 of the GPS position calculating apparatus 10 located at the reference point, from the acquired orbital speed v and a time difference “t” obtained by subtracting the transmission time tb from the reception time tr as (t=tr−tb). The computing unit 14 further calculates an angle α1, α2, α3 (collectively designated by “α”) which a line segment connecting the position B of each GPS satellite with a position O of the reference point forms with respect to the horizon.

At a third step of operation, the computing unit 14 calculates a distance cs1, cs2, cs3 (collectively designated as “cs”) from the position of the reference point to the position A of each GPS satellite 21, 22, 23 at the transmission time tb on the basis of a distance or range ct of the line segment and the angle α that are calculated at the second step and the altitude h acquired at the first step. The computing unit 14 thus calculates a pseudorange.

At a fourth step of operation, the computing unit 14 calculates the position of each respective GPS satellite at the transmission time from the distances cs between the position O of the reference point and the respective positions A of the at least three GPS satellites 21-23 that are calculated at the third step.

The first to fourth operation steps are programmed in advance and stored in the storage unit 16. The controller 15 constituted by, for example, a microprocessor sequentially retrieves and executes the program stored in the storage unit 16, urging the computing unit 14 to perform calculation of the angles α and distances cs (pseudoranges) and calculation of the position of each GPS satellite at the signal transmission time tb.

The storage unit 16 also stores other pieces of information concerning the center position and radius “r” of the earth, frequencies of the GPS satellites 21, 22, 23, and the speed “c” of light that are referenced by the controller 15.

As thus far described, operation to calculate the angle α, distance cs (pseudorange) and the position A of each GPS satellite at the signal transmission time tb is achieved by the computing unit 14 under the control of the control unit 15. However, the control unit 15 may undertake such calculating operation in place of the computing unit 14.

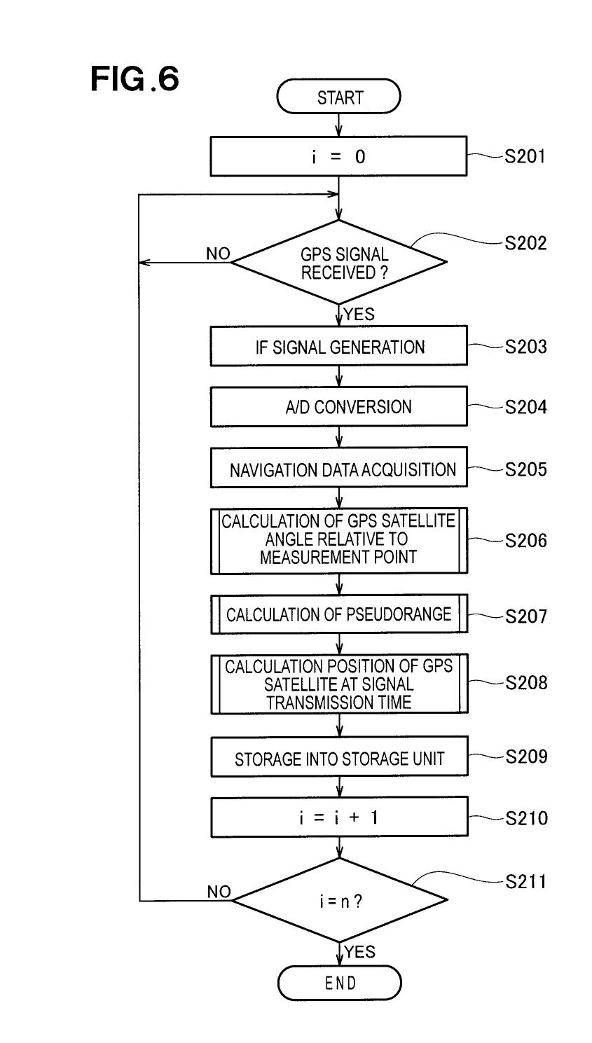

Operation of the GPS position calculating apparatus 10 used as GPS satellite position calculating apparatus according to the second embodiment of the present invention will be described in detail with reference to a flowchart shown in FIG. 6. The flowchart shows a sequence of operations to be executed by the controller 15.

At step S201, the controller 15 sets a count value i of a counter assigned to the program to “0”. The counter counts the number of target GPS satellites from which signals are to be received. In the illustrated embodiment, the number “n” of target GPS satellites is three, and these three target Satellites 21, 22 and 23 are used for detecting a position of the reference point.

At step S202, the controller 15 determines as to whether a high-frequency analog signal transmitted from the first GPS satellite 21 has been received by the RF circuit 11b. If an affirmative determination is made (YES) at step S202, the control process goes on to step S203, where the RF circuits 11b down-converts the high-frequency analog signal into an IF analog signal and outputs the IF analog signal to the A/D converter 12.

Subsequently, the controller 15 issues a signal conversion order to the A/D converter 12, whereupon at step S204, the A/D converter converts the IF analog signal to a digital signal and outputs the digital signal to the correlator 13 and the controller 15. Subsequently, at step S205 the controller 15 acquires navigation data (orbital speed v, transmission time tb, and altitude h) from the digital signal and outputs the acquired navigation data to the computing unit 14. At the same time, the controller 15 issues a pseudorange calculation order to the computing unit 14.

At step S206, upon receipt of the pseudorange calculation order from the controller 15, the computing unit 14 starts calculating a position B of the GPS satellite 21 at a reception time tr when the signal from the GPS satellite 21 is received at the receiver station (position O of the reference point) by using the orbital speed v acquired at step S205 and a time difference t obtained by subtracting the transmission time tb from the reception time tr as (t=tr−tb).

The computing unit 14 further calculates an angle α, which a line segment connecting the position B of the GPS satellite 21 with a position O of the reference point forms with respect to the horizon e. Subsequently, by using the calculated angle α and the acquired orbital speed v of the GPS satellite 21, the computing unit 14 calculates a angle β which a line segment connecting the position A of the GPS satellite 21 at the signal transmission time tb with the position O of the reference point forms with respect the horizon. Calculation of the angles α and β is done in accordance with the foregoing angle relational expression (3).

Then, at step S207 the computing unit 14 calculates a distance cs between the position A of the GPS satellite 21 and the position O of the reference point as a pseudorange on the basis of the angle α calculated at step S206, a distance ct between the position B of the GPS satellite 21 and the position O of the reference point which is already known, and the acquired altitude h of the GPS satellite 21. In this instance, the computing unit 14 solves the foregoing equation (5) to calculate the distance cs (pseudorange).

Subsequently, at step S208, the computing unit 14 calculates a position Ai (=Si (xi, yi, zi)) of the GPS satellite 21 at the signal transmission time tb by solving the following equation (10) using the distance cs (pseudorange) between the position A of the GPS satellite 21 and the known position O of the reference point. The computing unit 14 outputs the result of calculation (calculated position Ai of the GPS satellite 21) to the controller 15.

$$\{ \begin{matrix}cs 1 = \sqrt{{( x 1 - x )}^{2} + {( y 1 - y )}^{2} + {( z 1 - z )}^{2}} \\ cs 2 = \sqrt{{( x 2 - x )}^{2} + {( y 2 - y )}^{2} + {( z 2 - z )}^{2}} \\ cs 3 = \sqrt{{( x 3 - x )}^{2} + {( y 3 - y )}^{2} + {( z 3 - z )}^{2}}\end{matrix} \qquad ( 10 )$$

where cs1 is the range of the line segment connecting the position A of the first GPS satellite with the position O of the reference point, cs2 is the range of the line segment connecting the position A of the second GPS satellite with the position O of the reference point, cs3 is the range of the line segment connecting the position A of the third GPS satellite with the position of the reference point, (x, y, z) is the position coordinate of the reference point, (x1, y1, z1) is the position coordinate of the first GPS satellite, (x2, y2, z2) is the position coordinate of the second GPS satellite, and (x3, y3, z3) is the position coordinate of the third GPS satellite.

Upon receipt of information about the position A of the GPS satellite 21 from the computing unit 14, the controller 15 first stores the received information in a predetermined storage area of the storage unit 16 at step S209 and then increments the count value i of the counter by one at step S210.

Subsequently, at step S211, the controller 15 compares the count value i of the counter with the number “n” of target GPS satellites. If the count value i is less the number “n” of target GPS satellites (i<n), a negative determination (“NO”) will be made at S211. Thus, the control process returns to step S202 (GPS signal reception judgment process) and, thereafter, those processing steps S202 to S210 which are already discussed above with respect to the signal from the target GPS satellite 21 will be repeated for each of the remaining target GPS satellites 22, 23. During that time, the computing unit 14 calculates the distance cs between the position A of each GPS satellite at the signal transmission time tb and the known position O of the reference point to thereby get a pseudorange for each respective GPS satellite, and calculates from the pseudoranges of the GPS satellites 21-23, positions A of the respective GPS satellites 21, 22, 23 at the signal transmission time tb by solving the foregoing equation (10), where the position of each respective GPS satellites 21-23 is represented by components of three-dimensional coordinate, such as S1 (x1, y1, z1), S2 (x2, y2, z2) and S3 (x3, y3, z3).

When it is confirmed that the count value i has reached the number “n” of target GPS satellites (i=n) at step S211, this means that an affirmative determination (“YES”) is made at S211 and the controller 15 will terminate the afore-mentioned series of operations that have been performed to calculate the GPS satellite positions A.

According to the second embodiment of the GPS position calculating apparatus as used in a GPS satellite position calculating apparatus, the distance between the position A of each GPS satellite at the signal transmission time and the known position O of the reference point is used as a pseudorange in the process of calculating the position of the GPS satellite. Unlike the conventional arrangement in which the distance between the position B of each GPS satellite at the signal reception time and the known position O of the reference point is used as a pseudorange in the process of calculating the position A of the GPS satellite, the aforesaid arrangement of the present invention is able to simplify the calculation method or procedure, increase the calculation accuracy, and eventually improve the accuracy in detecting the position of GPS satellite. Calculation of the pseudorange requires data about the orbit speed v and angle α of the GPS satellite, but merely by replacing the pseudorange ct the GPS satellite at the signal reception time with the pseudorange cs at the signal transmission time, the pseudorange calculation can be achieved simply with increased accuracy.

In the flowchart shown in FIG. 6, step S205 corresponds to a navigation data acquiring section, which forms a part of the GPS satellite position calculating apparatus and which is configured to acquire orbit information from the signals, the orbit information including signal transmission time tb, orbital speed v and altitude h of each of the at least three GPS satellite.

Step S206 corresponds to an elevation angle calculating section, which forms a part of the GPS satellite position calculating apparatus and which is configured to calculate a position B of each respective GPS satellite at reception time tr, by using the acquired orbital speed v and a time difference t obtained by subtracting the transmission time tb from the reception time tr as (t=tr−tb) and to further calculate a angle α which a line segment connecting the position B of each GPS satellite with a position O of the reference point forms with respect to the horizon.

Step S207 corresponds to a pseudorange calculating section, which forms a part of the GPS satellite position calculating apparatus and which is configured to calculate a range cs from the position O of the reference point to a position A of each GPS satellite at the transmission time tb on the basis of the range ct from the position O of the reference point to the position B of each GPS satellite, the altitude h and the angle α.

Step S208 corresponds to a satellite position calculating section, which forms a part of the GPS satellite position calculating apparatus and which is configured to calculate the position A of each respective GPS satellite at transmission time, from the calculated distance cs between the position O of the reference point and the position A of each of the at least three GPS satellites 21-23.

Description will next be made about a third embodiment of the present invention in which the distance ct between the GPS satellite position at signal reception time tr and the portion O of the reference point is used as a pseudorange in the process of calculating the position of the GPS satellite. In the third embodiment, the GPS position calculating apparatus 10 of the configuration shown in FIG. 1 is used as a GPS satellite position calculating apparatus with the exception that the computing unit 14 is configured to achieve a series of operations under program control by the controller 15, wherein the operations starts at a first step and ends at a forth step, as will be discussed below.

At the first step of operation, the computing unit 14 acquires orbit information of the GPS satellites 21, 22, 23 from navigation data contained in the signals received by the RF circuit 11b. The orbit information includes a position A1, A2, A3 (collectively designated as “A”), clock time tb1, tb2, b3 (collectively designated as “tb”), orbital speed v1, v2, v3 (collectively designated as “v”), and altitude h1, h2, h3 (collectively designated as “h”) of each of the GPS satellites 21, 22, 23 at a transmission time when each GPS satellite 21, 22, 23 transmits a respective signal.

At a second step of operation, the computing unit 14 calculates a position B1, B2, B3 (collectively designated as “B”) of each respective GPS satellites 21, 22, 23 at a reception time “tr” when the signal from each GPS satellite is received at the receiver 11 of the GPS position calculating apparatus 10 located at the reference point, from the acquired orbital speed v and a time difference “t” obtained by subtracting the transmission time tb from the reception time tr as (t=tr−tb).

At a third step of operation, the computing unit 14 calculates a distance ct1, ct2, ct3 (collectively designated as “ct”) between the position O of the reference point and the GPS satellite position B at reception time tr (obtained at the second step) as a pseudorange.

At a fourth step of operation, the computing unit 14 calculates the position of each respective GPS satellite at the transmission time from the distance ct between the position O of the reference point and the position at the GPS satellite position B at the reception time tr that has been calculated at the third step with respect to each of the at least three GPS satellites 21-23.

The first to fourth operation steps are programmed in advance and stored in the storage unit 16. The controller 15 constituted by, for example, a microprocessor sequentially retrieves and executes the program stored in the storage unit 16, urging the computing unit 14 to perform calculation of the position of the GPS satellites on the basis of the distance ct (pseudorange).

The storage unit 16 also stores other pieces of information concerning the center position and radius “r” of the earth, frequencies of the GPS satellites 21, 22, 23, and the speed “c” of light that are referenced by the controller 15.

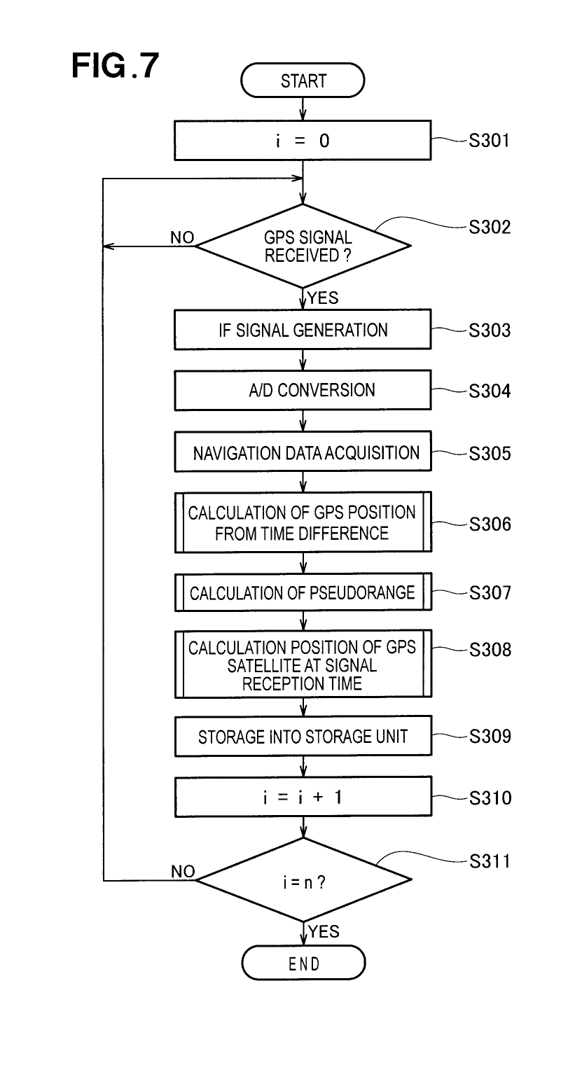

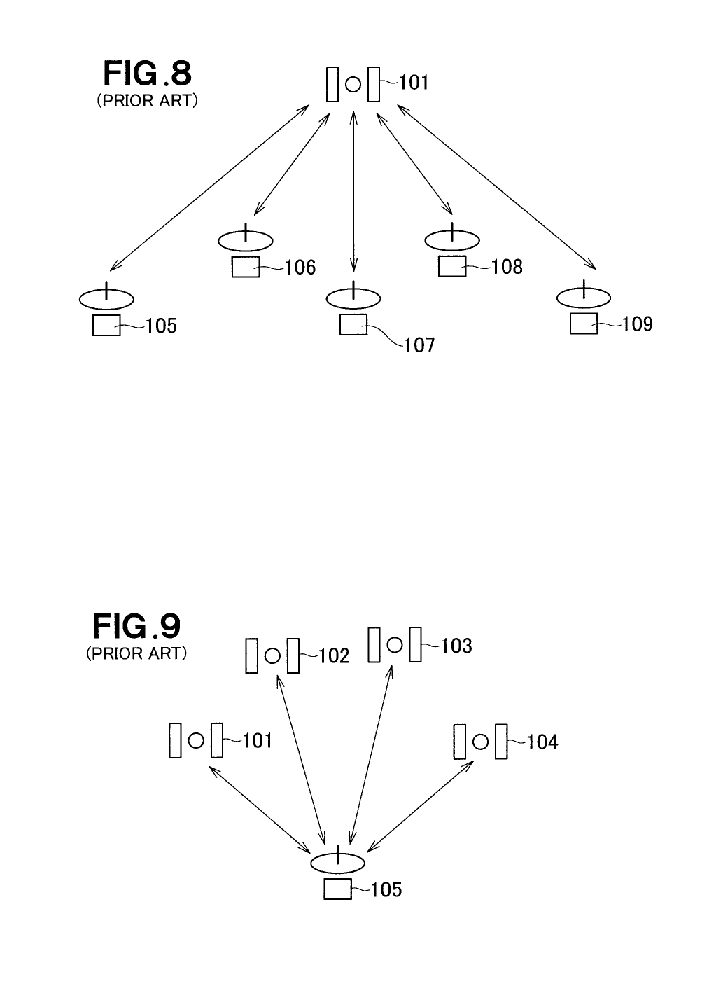

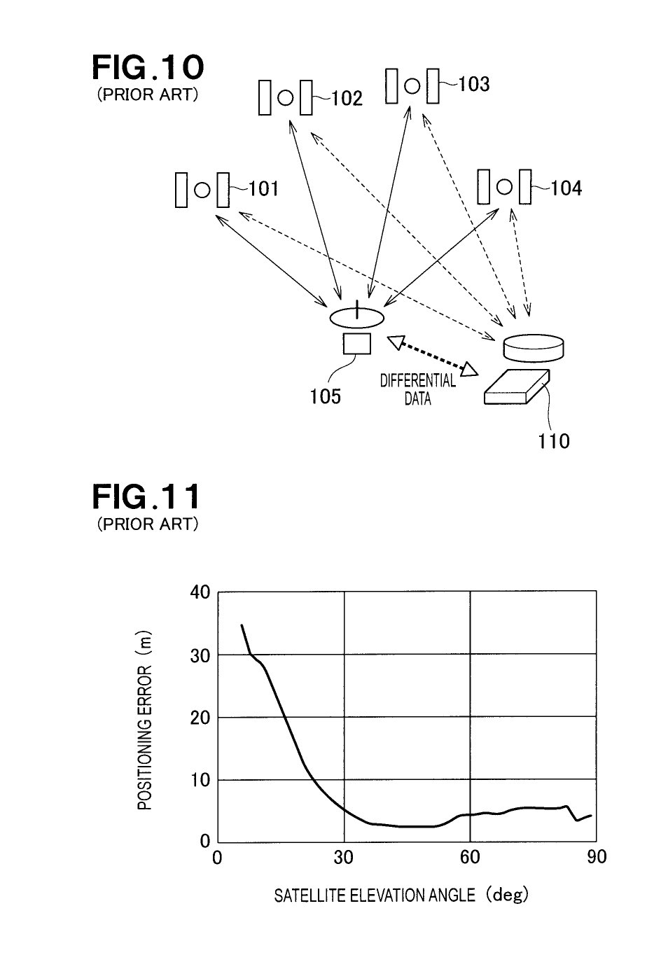

Operation of the GPS position calculating apparatus 10 used as GPS satellite position calculating apparatus according to the third embodiment of the present invention will be described in detail with reference to a flowchart shown in FIG. 7 while focusing on differences from the second embodiment. These operations, which are achieved by consecutive steps S301 to S304 are the same as those achieved by steps S201 to S204 in the second embodiment, and description will begins at step S305 where navigation data is acquired.

At step S305, the controller 15 acquires navigation data (orbital speed v, transmission time tb, and altitude h) from the digital signal and outputs the acquired navigation data to the computing unit 14. At the same time, the controller 15 issues a pseudorange calculation order to the computing unit 14.

At step S306, upon receipt of the pseudorange calculation order from the controller 15, the computing unit 14 starts calculating a position B of the GPS satellite 21 at a reception time tr when the signal from the GPS satellite 21 is received at the receiver station (position O of the reference point) by using the orbital speed v acquired at step S305 and a time difference t obtained by subtracting the transmission time tb from the reception time tr as (t=tr−tb). Subsequently at step S307, the time difference (t=tr−tb) is multiplied by the speed of light so that the distance ct between the GPS satellite and the reference point at the reception time tr of the signal at the reference point is calculated as a pseudorange.

Subsequently, at step S308, the computing unit 14 calculates a position Bi (=Si (xi,yi,zi)) of the GPS satellite 21 at the signal transmission time tb by solving the foregoing equation (7) using the distance ct (pseudorange) between the position B of the GPS satellite 21 and the known position O of the reference point. The computing unit 14 outputs the result of calculation (calculated position B of the GPS satellite 21) to the controller 15.

Upon receipt of information about the position B of the GPS satellite 21 from the computing unit 14, the controller 15 first stores the received information in a predetermined storage area of the storage unit 16 at step S309 and then increments the count value i of the counter by one at step S310.

Subsequently, at step S311, the controller 15 compares the count value i of the counter with the number “n” of target GPS satellites. If the count value i is less the number “n” of target GPS satellites (i<n), a negative determination (“NO”) will be made at S311. Thus, the control process returns to step S302 (GPS signal reception judgment process) and, thereafter, those processing steps S302 to S310 which are already discussed above with respect to the signal from the target GPS satellite 21 will be repeated for each of the remaining target GPS satellites 22, 23. During that time, the computing unit 14 calculates the distance ct between the position B of each GPS satellite at the signal reception time tb and the known position O of the reference point to thereby get a pseudorange for each respective GPS satellite, and calculates from the pseudoranges of the GPS satellites 21-23, positions B of the respective GPS satellites 21, 22, 23 at the signal reception time tr by solving the foregoing equation (7), where the position of each respective GPS satellites 21-23 is represented by components of three-dimensional coordinate, such as S1 (x1, y1, z1), S2 (x2, y2, z2) and S3 (x3, y3, z3).

When it is confirmed that the count value i has reached the number “n” of target GPS satellites (i=n) at step S311, this means that an affirmative determination (“YES”) is made at S311 and the controller 15 will terminate the afore-mentioned series of operations that have been performed to calculate the GPS satellite positions B.

According to the third embodiment of the GPS position calculating apparatus as used in a GPS satellite position calculating apparatus, the distance between the position B of each GPS satellite at the signal transmission time and the known position O of the reference point is used as a pseudorange in the process of calculating the position B of the GPS satellite. Unlike the conventional arrangement in which the distance between the position A of each GPS satellite at the signal transmission time and the known position O of the reference point is used as a pseudorange in the process of calculating the position of the GPS satellite, the aforesaid arrangement of the present invention is able to simplify the calculation method or procedure, increase the calculation accuracy, and eventually improve the accuracy in detecting the position of GPS satellite. Furthermore, calculation of the GPS satellite position at the signal reception time does not require observation data to be supplied from a known receiver site on the earth and this arrangement adds to the degree of simplification of the calculation method of procedure.

Although in the third embodiment of the present invention just described above with reference to FIG. 7, the distance ct between the calculated position B of each GPS satellite and the known position O of the reference position is treated as a pseudorange, it is also possible according to the present invention to calculate from the position O of the reference point, a distance or range cs of a line segment connecting the position A of each GPS satellite with the position O of the reference point and use the calculated range cs of the line segment as a pseudorange. In this case, calculation quantity increases. However, because calculation of the pseudorange is possible without using elevation angle, this allows for the use of an existing GPS positioning system, leading to a reduction in calculation load.

In the flowchart shown in FIG. 7, step S305 corresponds to a navigation data acquiring section, which forms a part of the GPS satellite position calculating apparatus and which is configured to acquire orbit information from the signals, the orbit information including signal transmission time tb, orbital speed v and altitude h of each GPS satellite.

Steps S306 and S307 together correspond to a pseudorange calculating section, which forms a part of the GPS satellite position calculating apparatus and which is configured to calculate the position B of each GPS satellite at signal reception time tr from a time difference between the reception time tr and the transmission time tb and the acquired orbital speed v and further calculate the distance ct from the position O of the reference point to the position B of the GPS satellite at signal reception time tr.

Step S308 corresponds to a satellite position calculating section, which forms a part of the GPS satellite position calculating apparatus and which is configured to calculate the position B of each respective GPS satellite at reception time tr, from the calculated distance ct between the position O of the reference point and the position B of each of the at least three GPS satellites 21-23.

The GPS position calculating apparatus (including a GPS satellite position calculating apparatus) according to the present invention can be used not only in a car navigation system but also in the field of position detection of a measurement point, which is formed by a movable object, such as a marine vessel, aircraft, working vehicle, or mobile terminal. When used in combination with a method of estimating pseudorange error with reference to differential data, the GPS position calculating apparatus of the present invention is able to further improve the position detecting accuracy. The GPS position calculating apparatus of the present invention is also able to calculate an atmosphere delay and an ionosphere with high accuracy, which will greatly increase the weather observation accuracy.

Obviously, various minor changes and modifications of the present invention are possible in the light of teaching. It is to be noted that within the scope of the appended claims the invention may be practiced otherwise than as specifically described.

What is claimed is:

1. A position calculating method using a global positioning system (GPS) for determining the position of a measurement point on the horizon by a computing unit on the basis of signals received at a receiver on the measurement point from at least three GPS satellites, the method comprising:
a first step of acquiring orbit information from navigation data contained in the signals received at the receiver, said orbit information including a first position, clock time and orbital speed of each of the GPS satellites at a time when each GPS satellite transmits a respective signal;
a second step of calculating a second position of each GPS satellite at a time when the signal from each GPS satellite is received at the receiver, from the orbital speed and the clock time that are acquired at the first step;
a third step of calculating a range of a line segment connecting the second position of each GPS satellite calculated at the second step with a position of the measurement point, from a time difference obtained by subtracting the signal transmission time from the signal reception time; and
a fourth step of calculating the position of the measurement point from the respective ranges of the line segments calculated at the third step each connecting a respective one of the second positions of the at least three GPS satellites with the position of the measurement point.

2. A position calculating apparatus using a global positioning system (GPS) for determining the position of a measurement point on the horizon by a position calculating unit on the basis of signals received at a receiver on the measurement point from at least three GPS satellites, said apparatus comprising:
a navigation data acquiring section for acquiring orbit information from navigation data contained in the signals received at the receiver, said orbit information including a first position, clock time and orbital speed of each of the GPS satellites at a time when each GPS satellite transmits a respective signal;
a pseudorange calculating section for calculating a second position of each GPS satellite at a time when the signal from each GPS satellite is received at the receiver, from the orbital speed and clock time acquired by the navigation data acquiring section, and a time difference obtained by subtracting the acquired signal transmission time from the signal reception time, and further calculating a range of a first line segment connecting the calculated second position of each GPS satellite with a position of the measurement point; and
a position calculating section for calculating the position of the measurement point from the respective ranges of the first line segments calculated by the pseudorange calculating section each connecting a respective one of the second positions of the at least three GPS satellites with the position of the measurement point.

3. The position calculating apparatus according to claim 1, wherein said pseudorange calculating section further calculates a range of a second line segment connecting the first position of each GPS satellite with the position of the measurement point, from the position of the measurement point, and inputs the calculated range of the second line segment into the position calculating section as a pseudorange.

4. A GPS (global positioning system) satellite position calculating method wherein signals transmitted from at least three GPS satellites are received by a receiver at a reference point on the horizon, and the position of each respective GPS satellite at a reception time when the signal from each GPS satellite is received at the receiver is calculated by a computing unit on the basis of a known position of the reference point, the method comprising:
a first step of acquiring orbit information from the signals received at the receiver, the orbit information including a transmission time of each signal, and an orbital speed of each GPS satellite;
a second step of calculating a position of each GPS satellite at the reception time, from a time difference between the reception time and the transmission time and the acquired orbital speed;
a third step of calculating a distance from the position of the reference point to the position of each GPS satellite at the reception time; and
a fourth step of calculating the position of each respective GPS satellite at the reception time, from the calculated distances from the position of the reference point to the respective positions of the at least three GPS satellite at the reception time.

5. A GPS (global positioning system) satellite position calculating apparatus including a receiver for receiving signals transmitted from at least three GPS satellites, and a computing unit for calculating the position of each respective GPS satellite at a reception time when the signal from each GPS satellite is received at the receiver, on the basis of a known position of the reference point, the apparatus comprising:
a navigation data acquiring section for acquiring orbit information from the signals received at the receiver, the orbit information including a transmission time of each signal, and an orbital speed of each GPS satellite;
a pseudorange calculating section for calculating a position of each GPS satellite at the reception time, from a time difference between the reception time and the transmission time and the acquired orbital speed, and further calculating a distance from the position of the reference point to the calculated position of each GPS satellite at the reception time; and
a satellite position calculating section for calculating the position of each respective GPS satellite at the reception time, from the calculated distances from the position of the reference point to the respective positions of the at least three GPS satellite at the reception time.
